(19) United States
(12) Patent Application Publication
(10) Pub. No.: US 2017/0368685 A1
(43) Pub. Date: Dec. 28, 2017

(54) METHOD AND DEVICE FOR AUTOMATIC OBSTACLE AVOIDANCE OF ROBOT

(71) Applicant: Qihan Technology Co., Ltd., Shenzhen (CN)

(72) Inventors: Lvde Lin, Shenzhen (CN); Yongjun Zhuang, Shenzhen (CN)

(21) Appl. No.: 15/239,868

(22) Filed: Aug. 18, 2016

(30) Foreign Application Priority Data
Jun. 28, 2016 (CN) 201610486856.3

(51) Int. Cl. B25J 9/16; G05D 1/02

(52) U.S. Cl. CPC B25J 9/1676; G05D 1/0214; B25J 9/1694; Y10S 901/01; G05D 2201/0217

(57) ABSTRACT

A method for automatic obstacle avoidance of a robot includes: obtaining distance values between the robot and an obstacle detected by sensors arranged on a left side, middle part and right side of the robot respectively; when a minimum distance value detected by the sensors on the middle part is less than a threshold value, if a minimum distance value detected by the sensors on either the left side or the right side exceeds an obstacle critical distance, turning the robot 90 degrees towards the side where the minimum distance value exceeds the obstacle critical distance; when the minimum distance value detected by the sensors on the middle part exceeds the distance threshold value, if only the minimum distance value detected by the sensors on the left side exceeds the obstacle critical distance, turning the robot towards the left side by a first angle value.

### FIELD OF THE INVENTION

The present invention relates to the technical field of robots, and more particularly to a method for automatic obstacle avoidance of a robot.

### BACKGROUND

With the improvement of the intelligent control technology, more and more intelligent robots have entered the people's living. For example, home service robots, such as a sweeping robot, a window cleaning robot, and so on, can help the people finish daily ground sweeping or window cleaning works automatically and high-efficiently, and thus bring much convenience to the people's living.

During a working process of a home service robot, the robot usually needs to move indoors or outdoors automatically. In its moving process, the robot inevitably meets various obstacles, such as furniture, a wall, a tree, and so on. As a result, when the home service robot works, how to avoid the obstacles high-efficiently and accurately is an important technical point for ensuring a service quality of the intelligent robot.

When performing obstacle avoidance, an existing home service robot usually uses an IR (Infrared Ray) sensor or an ultrasonic sensor, for example, a periphery and a position of the robot rising upwardly are provided with sensors, wherein the front and the rear of the robot are provided with two sensors respectively, a left side and a right side of the robot are provided with a sensor respectively, and a highest position that extends upwardly from a top surface of the robot is provided with a sensor. Owing to the problem that the IR sensor and the ultrasonic wave sensor have low accuracies and are unstable, the existing robot can only adapt to a broad scene during an obstacle avoidance process, and has a weak adaptability in a relatively narrow scene (e.g., an aisle).

### BRIEF DESCRIPTION

A purpose of the present invention is providing a method for automatic obstacle avoidance of a robot, which aims at solving a problem in the prior art that an existing robot can only adapt to a broad scene during an obstacle avoidance process and has a weak adaptability in a relatively narrow scene (e.g., an aisle).

In a first aspect, one embodiment of the present invention provides a method for automatic obstacle avoidance of a robot, the method comprises:

obtaining distance values between the robot and an obstacle detected by a plurality of sensors arranged on a left side, a middle part and a right side of the robot respectively; the left side of the robot comprises sensors arranged on a left hand and a left foot of the robot respectively, the right side of the robot comprises sensors arranged on a right hand and a right foot of the robot respectively, and the middle part of the robot comprises sensors arranged on a head and a body portion of the robot respectively;

when a minimum distance value detected by the sensors on the middle part of the robot is less than a preset middle part distance threshold value, if a minimum distance value detected by the sensors on the left side or the right side exceeds a preset obstacle critical distance, turning the robot by 90 degrees towards the side where the minimum distance value detected by the sensors exceeds the preset obstacle critical distance, and recording a first turning angle;

when the minimum distance value detected by the sensors on the middle part of the robot exceeds the preset middle part distance threshold value, if only the minimum distance value detected by the sensors on the left side exceeds the preset obstacle critical distance, turning the robot towards the left side by a first angle value; if only the minimum distance value detected by the sensors on the right side exceeds the obstacle critical distance, turning the robot by the first angle value and recording a second turning angle; wherein the first angle value is less than 90 degrees and is greater than 0 degree.

In combination with the first aspect, in a first possible implementation method of the first aspect, the method further comprises:

when each of the minimum distance values detected by the sensors on both the left side and the right side of the robot is less than the preset obstacle critical distance, turning the robot by 180 degrees;

when each of the minimum distance values detected by the sensors on both the left side and the right side of the robot exceeds the preset obstacle critical distance, and the minimum distance value detected by the sensors on the middle part of the robot exceeds the preset middle part distance threshold value, controlling the robot to move ahead straightly.

In combination with the first aspect, in a second possible implementation method of the first aspect, the obstacle critical distance value is greater than a nearest critical distance represented as DRN and is less than a farthest critical distance represented as DRF, and the method further comprises:

when the minimum distance value detected by the sensors on the middle part of the robot exceeds the preset middle part distance threshold value, the minimum distance value detected by the sensors on either the left side or the right side of the robot is less than the preset obstacle critical distance, and the minimum distance value detected by the sensors on the other of the left side and the right side of the robot exceeds the farthest critical distance value, turning the robot towards the other of the left side and the right side of the robot by a second angle; wherein the second angle is less than 90 degrees and is greater than 0 degree.

In combination with the first aspect, in a third possible implementation method of the first aspect, the method further comprises:

if the minimum distance value detected by the sensors on the middle part of the robot exceeds the preset middle part distance threshold value, and each of the minimum distance values detected by the sensors on both the left side and the right side of the robot exceeds the preset obstacle critical distance, obtaining a previous angle value to be compensated, and turning the robot according to the angle value to be compensated.

In combination with the first aspect, in a fourth possible implementation method of the first aspect, each of the left side and the right side of the robot is provided with five sensors, which include two sensors arranged on a palm and an elbow respectively and three sensors arranged at outer sides of an ankle-joint, a knee-joint and a hip-joint respectively; the middle part of the robot is provided with seven sensors, which include two sensors arranged on a head, three sensors arranged on a body portion, and two sensors arranged on a front part of a sole and a front part of a knee respectively.

In a second aspect, the present invention provides a device for automatic obstacle avoidance of a robot, the device comprises:

a distance value obtaining unit configured for obtaining distance values between the robot and an obstacle detected by a plurality of sensors arranged on a left side, a middle part and a right side of the robot respectively; the left side of the robot comprises sensors arranged on a left hand and a left foot of the robot respectively, the right side of the robot comprises sensors arranged on a right hand and a right foot of the robot respectively, and the middle part of the robot comprises sensors arranged on a head and a body portion of the robot respectively;

a first turning unit configured for when a minimum distance value detected by the sensors on the middle part of the robot is less than a preset middle part distance threshold value, if a minimum distance value detected by the sensors on the left side or the right side exceeds a preset obstacle critical distance, turning the robot by 90 degrees towards the side where the minimum distance value detected by the sensors exceeds the preset obstacle critical distance, and recording a first turning angle;

a second turning unit configured for when the minimum distance value detected by the sensors on the middle part of the robot exceeds the preset middle part distance threshold value, turning the robot towards the left side by a first angle value if only the minimum distance value detected by the sensors on the left side exceeds the preset obstacle critical distance, turning the robot by the first angle value if only the minimum distance value detected by the sensors on the right side exceeds the obstacle critical distance, and recording a second turning angle; wherein the first angle value is less than 90 degrees and is greater than 0 degree.

In combination with the second aspect, in a first possible implementation method of the second aspect, the device further comprises:

a rotary unit configured for turning the robot by 180 degrees when each of the minimum distance values detected by the sensors on both the left side and the right side of the robot exceeds the preset obstacle critical distance; and

a straightly moving unit configured for controlling the robot to move ahead straightly when each of the minimum distance values detected by the sensors on both the left side and the right side of the robot exceeds the preset obstacle critical distance, and the minimum distance value detected by the sensors on the middle part of the robot exceeds the preset middle part distance threshold value.

In combination with the second aspect, in a second possible implementation method of the second aspect, the obstacle critical distance value is greater than a nearest critical distance represented as DRN and is less than a farthest critical distance represented as DRF, the device further comprises:

a third turning unit configured for when the minimum distance value detected by the sensors on the middle part of the robot exceeds the preset middle part distance threshold value, the minimum distance value detected by the sensors on either the left side or the right side of the robot is less than the preset obstacle critical distance, and the minimum distance value detected by the sensors on the other of the left side and the right side of the robot exceeds the farthest critical distance value, turning the robot towards the other of the left side and the right side of the robot by a second angle; wherein the second angle is less than 90 degrees and is greater than 0 degree.

In combination with the second aspect, in a third possible implementation method of the second aspect, the device further comprises:

a fourth turning unit configured for obtaining a previous angle value to be compensated and turning the robot according to the angle value to be compensated if the minimum distance value detected by the sensors on the middle part of the robot exceeds the preset middle part distance threshold value, and each of the minimum distance values detected by the sensors on both the left side and the right side of the robot exceeds the preset obstacle critical distance.

In combination with the second aspect, in a fourth possible implementation method of the second aspect, each of the left side and the right side of the robot is provided with five sensors, which include two sensors arranged on a palm and an elbow respectively and three sensors arranged at outer sides of an ankle-joint, a knee-joint and a hip-joint respectively; the middle part of the robot is provided with seven sensors, which include two sensors arranged on a head, three sensors arranged on a body portion, and two sensors arranged on a front part of a sole and a front part of a knee respectively.

In the present invention, the distance values between the robot and the obstacle, which are detected by the sensors arranged on the left side, the middle part and the right side of the robot respectively, are obtained using the obtaining robot; by arranging a plurality of sensors on a same side and obtaining minimum values of the detected distance values for comparison, each part of the robot can detect the obstacle more sensitively. Moreover, when there is no obstacle at either the left side or the right side, and there is an obstacle in front of the middle part or an object falling above the middle part, the robot is controlled to turn by 90 degrees towards the side without the obstacle; when there is neither obstacle in front of the middle part nor object falling above the middle part, and there is no obstacle on either the left side or the right side, the robot is controlled to turn by a first angle towards the side without the obstacle; in this way, a corresponding turning strategy can be adopted according to a condition of the obstacle, and turning data is recorded and can be used for a subsequent adjustment.

### BRIEF DESCRIPTION OF THE DRAWINGS

FIG. 1 is an implementation flow chart of a method for automatic obstacle avoidance of a robot provided by a first embodiment of the present invention;

FIG. 1a is a schematic view of status areas of obstacles having different distances provided by the first embodiment of the present invention;

FIG. 2 is an implementation flow chart of a method for automatic obstacle avoidance of a robot provided by a second embodiment of the present invention;

FIG. 3 is an implementation flow chart of a method for automatic obstacle avoidance of a robot provided by a third embodiment of the present invention;

FIG. 4 is a structural schematic view of a device for automatic obstacle avoidance of a robot provided by a fourth embodiment of the present invention.

### DETAILED DESCRIPTION

In order to make the purposes, technical solutions, and advantages of the present invention be clearer and more understandable, the present invention will be further described in detail hereafter with reference to the accompanying drawings and embodiments. It should be understood that the embodiments described herein are only intended to illustrate but not to limit the present invention.

A purpose of the embodiments of the present invention is providing a method for automatic obstacle avoidance of a robot, which aims at solving a problem in the prior art that: when a robot avoids an obstacle, a way of arranging sensors on a periphery of the robot and a position of the robot rising upwardly is usually adopted; since the used sensors are usually IR sensors or ultrasonic wave sensors, an accuracy of detected data is not high, and a stability is weak, thereby resulting in a problem that an existing robot can only adapt to a broad scene and cannot adapt to a relatively narrow scene when it automatically avoids the obstacle.

The present invention will be further described hereinafter with reference to the accompanying drawings.

### Embodiment I

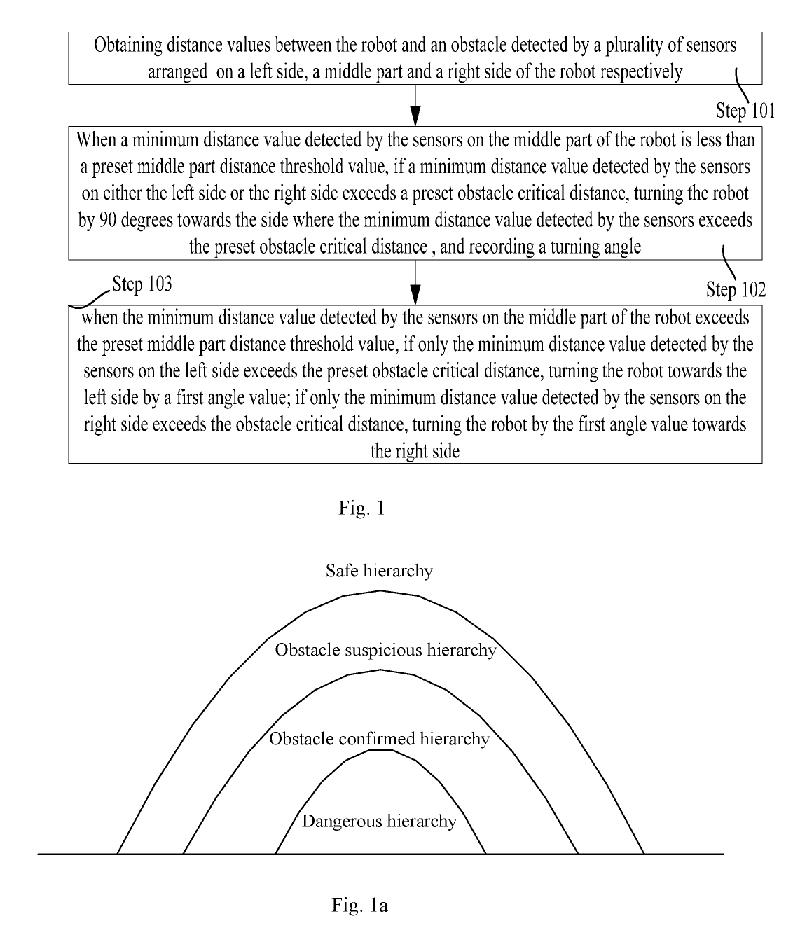

FIG. 1 illustrates an implementation flow chart of a method for automatic obstacle avoidance of a robot provided by a first embodiment of the present invention, which is described in detail as follows.

In a step S101, obtaining distance values between the robot and an obstacle detected by a plurality of sensors arranged at a left side, a middle part and a right side of the robot respectively; the left side of the robot comprises sensors arranged on a left hand and a left foot of the robot respectively, the right side of the robot comprises sensors arranged on a right hand and a right foot of the robot respectively, and the middle part of the robot comprises sensors arranged on a head and a body portion of the robot respectively.

Specifically, with respect to the sensors in this embodiment of the present invention, IR (Infrared Ray) sensors, ultrasonic wave sensors, or depth sensors can be used to detect the distance values. In order to judge the obstacle more accurately, when the robot moves ahead, front ranging sensors can be classified into three groups including a left side group, a middle part group and a right side group, which are respectively represented as front_IR_left, front_IR_middle and front IR_right. Wherein, the front_IR_left in total comprises five sensors, which are front left_arm_IRO, front_left_arm_IR1, front_foot_left_IRO, front_foot_left_IR1, front_foot left_IR2; the front_IR_middle in total comprises seven sensors, which are front_head IR1, front_head_IR2, front_torso_top_IR, front_torso_bottom_IR0, front_torso bottom_IR1, front_foot_middle_IR0, front_foot_middle_IR1; the front_IR_right in total comprises five sensors, which are front_right_arm_IR0, front_right_arm_IR1, front foot_right_IR0, front_foot_right_IR1, front_foot_right_IR2.

In the present invention, a preferred method for arranging sensors comprises:

each of the left side and the right side of the robot is provided with five sensors, which comprise two sensors arranged on a palm and an elbow of the robot respectively and three sensors arranged at outer sides of an ankle-joint, a knee-joint and a hip-joint of the robot respectively; the middle part of the robot is provided with seven sensors, which include two sensors arranged on the head, three sensors arranged on the body portion, and two sensors arranged at a front part of a sole and a front part of a knee respectively. In this way, the robot can detect obstacle information as accurately and timely as possible through the arranged sensors, and a sensitivity of obstacle avoidance of the robot can be improved.

Wherein, output values of the sensors arranged on the left side, the sensors arranged on the middle part and the sensors arranged on the right side depend on a minimum distance value detected by all sensors in each of the three groups. For example, distance values between the robot and the obstacle detected by the left group front_IR_left include L1, L2, L3, L4, L5; a minimum distance value in each group is selected and taken as an output value of the distance between the left side of the robot and the obstacle, wherein the left side minimum value is represented as DL=min {L1, L2, L3, L4, L5}. Similarly, an output value ML of the distance between the middle part of the robot and the obstacle and an output value RL of the distance between the right side of the robot and the obstacle can be calculated.

When the robot meets the obstacle in a moving process, according to different detection hierarchies where the robot lies, the robot can be controlled to perform different movements. When the robot lies in a suspicious hierarchy, the robot slows down, and tentatively moves ahead to approach the obstacle; when the robot lies in an obstacle confirmation hierarchy, an obstacle avoidance procedure is actuated; when the robot lies in a dangerous hierarchy, a movement of the robot should be stopped. As shown in FIG. 1a, according to the detected obstacle information, the robot inquires an obstacle avoidance strategy table, such that the robot is instructed to perform obstacle avoidance movements.

Wherein, threshold ranges corresponding to different areas are shown in the following table:

| Detection Hierarchy | Threshold range |
|---|---|
| Safe hierarchy | >1.2 m |
| Obstacle suspicious hierarchy | 0.9 m-1.2 m |
| Obstacle confirmation hierarchy | 0.6 m-0.9 m |
| Dangerous hierarchy | 0.3 m-0.6 m |

In a step S102, when a minimum distance value detected by the sensors arranged on the middle part of the robot is less than a preset middle part distance threshold value, if a minimum distance value detected by the sensors arranged on either the left side or the right side exceeds a preset obstacle critical distance, turning the robot by 90 degrees towards the side where the minimum distance value detected by the sensors exceeds the preset obstacle critical distance, and recording a turning angle.

In this embodiment of the present invention, when the sensors arranged on the middle part of the robot detect that there is a falling object or an obstacle in front of the middle part, and there is no obstacle on the left side or the right side, the robot can be controlled to turn towards the side without the obstacle by 90 degrees. Wherein, the left side and the right side specifically comprise conditions as follows:

when there is no obstacle at the left side but an obstacle at the right side, the robot is controlled to rotate towards the left side by 90 degrees;

when there is an obstacle at the left side but no obstacle at the right side, the robot is controlled to turn towards the right side by 90 degrees;

when there is no obstacle at both the left side and the right side, the robot can be controlled to rotate by 90 degrees towards any one of the left side and the right side.

In a step S103, when the minimum distance value detected by the sensors arranged on the middle part of the robot exceeds the preset middle part distance threshold value, if only the minimum distance value detected by the sensors arranged on the left side exceeds the preset obstacle critical distance value, turning the robot towards the left side by a first angle value; if only the minimum distance value detected by the sensors arranged on the right side exceeds the preset obstacle critical distance value, turning the robot towards the right side by the first angle value, and recording a turning angle; the first angle value is less than 90 degrees and is more than 0 degree.

When it is detected that there is no object falling above the middle part and there is no obstacle in front of the middle part, the present invention further comprises a method for controlling the robot to turn by a first angle value, which is specifically described as follows:

when it is detected that there is no object falling above the middle part and there is no obstacle in front of the middle part, if it is detected that there is no obstacle at the left side but an obstacle at the right side, turning the robot towards the left side by the first angle value;

when it is detected that there is no object falling above the middle part and there is no obstacle in front of the middle part, if it is detected that there is no obstacle at the right side but an obstacle the left side, turning the robot by the right side by the first angle value.

The first angle value is less than 90 degrees and greater than 0 degree, in a preferred embodiment, the first angle value can be between 45 degrees and 75 degrees; for example, the first angle value can be selected to be 60 degrees or the like.

Of course, in a further preferred embodiment, the present invention can further comprise:

when each of minimum distance values detected by the sensors arranged on the left side and the right side of the robot is less than the preset obstacle critical distance, turning the robot by 180 degrees;

when each of the minimum distance values detected by the sensors arranged on the left side and the right side of the robot exceeds the preset obstacle critical distance, and the minimum distance value detected by the sensors arranged on the middle part of the robot exceeds the preset middle part threshold value, controlling the robot to move ahead straightly.

In other words, no matter whether there is an object falling above the middle part or an obstacle ahead of the middle part, when it is detected that there are obstacles on both the left side and the right side, the robot is turned by 180 degrees, so that a problem that the robot get stuck between the obstacles can be avoided.

When there is no obstacle at the front, the left side and the right side of the robot, and there is no object falling above the robot, the robot can be controlled to go on moving ahead.

In the present invention, the distance values between the robot and the obstacle, which are detected by the sensors arranged on the left side, the middle part and the right side of the robot respectively, are obtained using the obtaining robot; by arranging a plurality of sensors on a same side, and obtaining minimum distance values of the detected distance values to make a comparison, each part of the robot can detect the obstacle more sensitively. Moreover, when there is no obstacle at either the left side or the right side, and there is an obstacle in front of the middle part or an object falling above the middle part, the robot is controlled to turn by 90 degrees towards the side without the obstacle; when there is neither obstacle in front of the middle part nor object falling above the middle part, and there is no obstacle on either the left side or the right side, the robot is controlled to turn by a first angle towards the side without the obstacle; in this way, a corresponding turning strategy can be adopted according to a condition of the obstacle, and turning data is recorded and can be used for a subsequent adjustment.

### Embodiment II

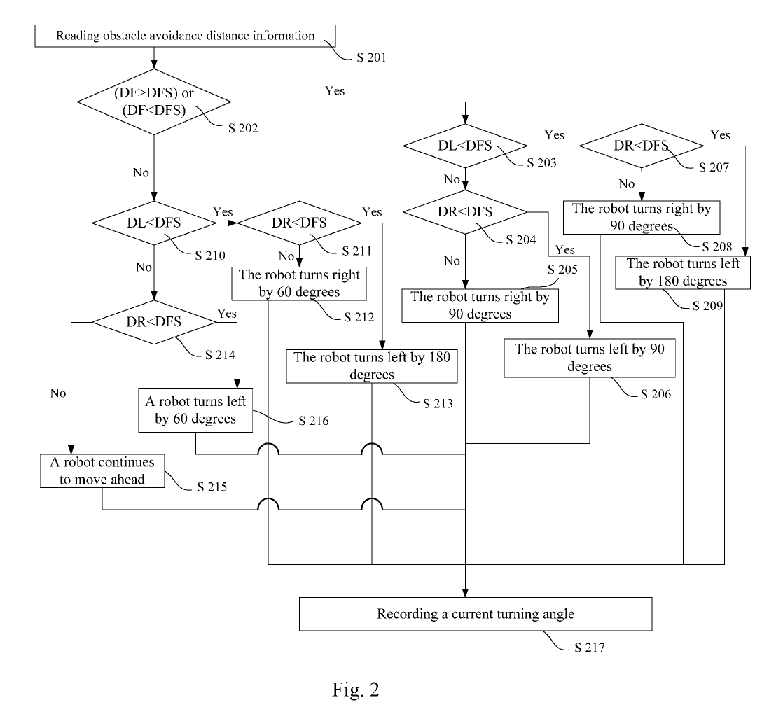

FIG. 2 illustrates an implementation flow chart of a method for automatic obstacle avoidance of a robot provided by a second embodiment of the present invention, which is described in detail as follows:

In a step S201, by the robot, reading distance data detected by sensors, the distance data can include sensor data detected by the seventeen sensors described in the embodiment I; and with respect to sensor data in each group, automatically obtaining a minimum numerical value and taking the minimum numerical value as an output value of this group of sensors. Wherein, DL, DM, DR, and DF are used to represent minimum distances of a left side of the robot, a middle part of the robot, a right side of the robot, and a falling prevention respectively, and DS is used to represent an obstacle critical distance of an obstacle confirmed hierarchy. DFS represents an obstacle critical distance of the falling prevention. In each obstacle avoidance process, a turning direction and a moving distance should be recorded, such that a turning compensation can be implemented after the obstacle avoidance, a previous moving direction of the robot can be restored and the robot can be controlled to go on moving in the previous moving direction.

In a step S202, judging whether there is a possibility of falling or there is an obstacle in front of the middle part.

In a step S203, when there is a possibility of falling or there is an obstacle in front of the middle part, detecting whether there is an obstacle on the left side.

In a step S204, if there is no obstacle on the left side, detecting whether there is an obstacle on the right side.

In a step S205, if there is no obstacle on the right side, turning the robot right by 90 degrees.

In a step S206, if there is an obstacle on the right side, turning the robot left by 90 degrees.

In a step 207, determining that there is obstacle on the left side in the step S203, and further judging whether there is obstacle on the right side.

In a step S208, determining that there is no obstacle on the right side, and turning the robot right by 90 degrees.

In a step S209, determining that there is an obstacle on the right side, turning the robot by 180 degrees, and turning the moving direction of the robot around.

In a step S210, confirming that there is no possibility of falling in the step S202 and there is no obstacle in front of the middle part, and further judging whether there is obstacle on the left side.

In a step S211, if there is an obstacle on the left side, further judging whether there is an obstacle on the right side.

In a step S212, if there is no obstacle on the right side, controlling the robot to turn right by a first angle value; in this embodiment of the present invention, the first angle value is 60 degrees.

In a step S213, if there is an obstacle on the right side, controlling the robot to rotate by 180 degrees and turning the moving direction of the robot around.

In a step S214, if there is no obstacle on the left side in the step S210, further judging whether there is an obstacle on the right side or not.

In a step S215, if there is no obstacle on the right side, controlling the robot to go on moving ahead.

In a step S216, if there is an obstacle on the right side, turning the robot left by the first angle value; in this embodiment of the present invention, the first angle value is 60 degrees.

In a step S217, recording turning angles in the step S215, the step S216, the step S212, the step S213, the step S205, the step S206, the step S208, and the step S209, that is, angles for compensation. It is convenient for obtaining a previous angle value to be compensated and turning according to the angle value to be compensated when a minimum distance value detected by sensors arranged on the middle part of the robot exceeds a preset middle part distance threshold value and each of minimum distance values detected by sensors arranged on the left side and the right side exceeds a preset obstacle critical distance, thereby controlling the robot to move ahead according to a restored previous moving direction thereof.

This embodiment of the present invention is an implementation strategy of a straightly moving obstacle avoidance strategy, according to this embodiment of the present invention, it is possible to perform effective obstacle avoidances aiming at various obstacle conditions encountered by the robot, thereby improving a flexibility of an automatic obstacle avoidance of the robot.

### Embodiment III

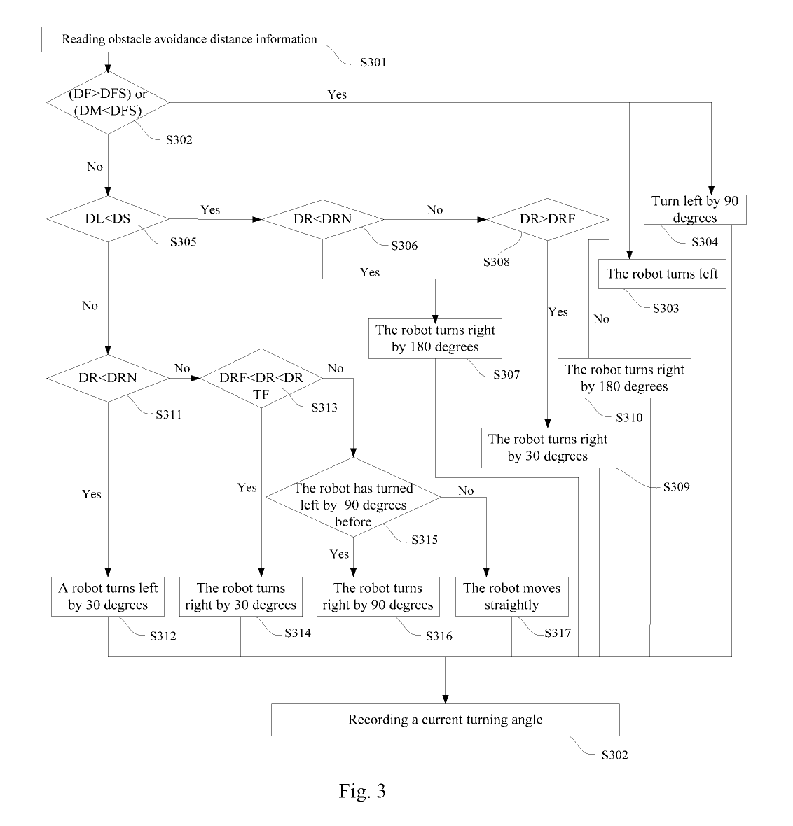

FIG. 3 illustrates an implementation flow chart of a method for automatic obstacle avoidance of a robot provided by a third embodiment of the present invention, which is described in detail as follows:

In this embodiment of the present invention, DS is used to represent a critical distance of an obstacle confirmed hierarchy. DFS represents an obstacle critical distance of a falling prevention, DRN represents a nearest critical distance for which the robot moves towards a right side, DRF represents a farthest critical distance for which the robot moves towards the right side, DRTF represents an adjacent wall distance between the robot and a wall when the robot is far away from the wall and no longer moves along the wall.

In a step S301, by the robot, reading distance data detected by sensors, which can include sensor data detected by the seventeen sensors described in the Embodiment I, and aiming at sensor data in each group, automatically obtaining a minimum numerical value and taking the minimum numerical value as an output value of this group of sensors. Wherein, DL, DM, DR, and DF are used to represent minimum distances of a left side of the robot, a middle part of the robot, a right side of the robot, and the falling prevention respectively.

In a step S302, judging whether there is a possibility of falling or there is an obstacle in front of the middle part.

In a step S303, if there is an obstacle in front of the middle part, controlling the robot to turn left and move in a direction that is parallel to the obstacle. Wherein, whether the robot is parallel to the obstacle can be detected by a turning method. When there is an obstacle in the front of the robot, the robot can be controlled to turn left by 90 degrees; several ranging distance values on the right side of the robot can be used to make a comparison; if these ranging distance values present an increasing law or a decreasing law, it is indicated that the robot is parallel to the obstacle.

In a step S304, if it is detected that there is a possibility of falling, controlling the robot to turn left by 90 degrees.

In a step S305, if there is no the possibility of falling and there is no obstacle in front of the middle part, further judging whether there is an obstacle on the left side.

In a step S306, when there is an obstacle on the left side, detecting whether a distance between the robot and the obstacle on the right side is less than the nearest critical distance.

In a step 307, if the distance between the robot and the obstacle on the right side is less than the nearest critical distance, controlling the robot to turn right by a second angle value; in a preferred embodiment, the second angle value is 30 degrees, which is less than the first angle value.

In a step S308, if the distance between the robot and the obstacle on the right side exceeds the nearest critical distance, judging whether the distance between the robot and the obstacle on the right side exceeds the farthest critical distance.

In a step S309, if the distance between the robot and the obstacle on the right side exceeds the farthest critical distance, controlling the robot to turn left by a second angle value; the second angle value is preferably 30 degrees.

In a step S310, if the distance between the robot and the obstacle on the right side is less than the farthest critical distance, controlling the robot to turn by 180 degrees.

In a step S311, if there is no obstacle on the left side in the step S305, further judging whether there is an obstacle on the right side of the robot.

In a step S312, if there is an obstacle on the right side of the robot, controlling the robot to turn left by the second angle value, which is preferably 30 degrees.

In a step S313, if there is no obstacle on the right side of the robot, detecting whether the distance between the robot and the obstacle on the right side is greater than the farthest critical distance and less than the adjacent wall distance.

In a step S314, if the distance between the robot and the obstacle on the right side is greater than the farthest critical distance and less than the adjacent wall distance, controlling the robot to turn right by the second angle value, which is preferably 30 degrees.

In a step S315, if the distance between the robot and the obstacle on the right side exceeds the adjacent wall distance, detecting whether there is previous data of turning left, such as 90 degrees.

In a step S316, if there exists data of turning left, controlling the robot to turn right by, for example, 90 degrees.

In a step S317, if there is no data of turning left, controlling the robot to move straightly.

In a step S318, recording turning angles in the step S312, the step S314, the step S316, the step S317, the step S307, the step S309, the step S310, the step S303, and the step S304.

In this embodiment of the present invention, in a moving process of the robot, when a distance between the robot and the obstacle falls within an obstacle confirmed area, a classification judgment can be further performed, and a corresponding rotation control can be adopted according to different distance values, which is helpful for further improving a convenience of a movement of the robot.

### Embodiment IV

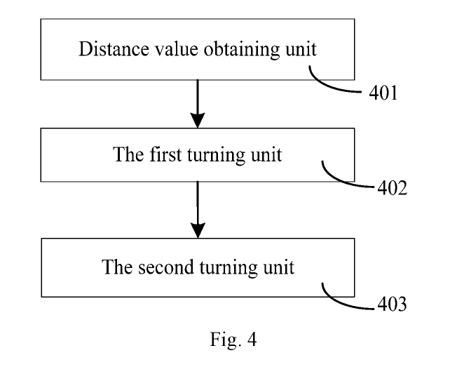

FIG. 4 illustrates a structural schematic view of a device for automatic obstacle avoidance of a robot provided by a fourth embodiment of the present invention, which is described in detail as follows:

The device for automatic obstacle avoidance of the robot in the embodiment of the present invention comprises:

a distance value obtaining unit 301 configured for obtaining distance values between the robot and an obstacle detected by a plurality of sensors on a left side, a middle part and a right side of the robot respectively; the left side of the robot comprises sensors on a left hand and a left foot of the robot respectively, the right side of the robot comprises sensors on a right hand and a right foot of the robot respectively, the middle part of the robot comprises sensors on a head and a body portion of the robot respectively;

a first turning unit 302 configured for when a minimum distance value detected by the sensors arranged on the middle part of the robot is less than a preset middle part distance threshold value, if a minimum distance value detected by the sensors on either the left side or the right side exceeds a preset obstacle critical distance, turning the robot by 90 degrees towards the side where the minimum distance value detected by the sensors exceeds the preset obstacle critical distance, and recording a first turning angle;

a second turning unit 303 configured for when the minimum distance value detected by the sensors on the middle part of the robot exceeds the preset middle part distance threshold value, turning the robot towards the left side by a first angle value if only the minimum distance value detected by the sensors on the left side exceeds the preset obstacle critical distance, turning the robot by the first angle value if only the minimum distance value detected by the sensors on the right side exceeds the obstacle critical distance, and recording a second turning angle; wherein the first angle value is less than 90 degrees and is greater than 0 degree.

Preferably, the device further comprises:

a rotary unit configured for turning the robot by 180 degrees when each of the minimum distance values detected by the sensors on both the left side and the right side of the robot exceeds the preset obstacle critical distance; and

a straightly moving unit configured for controlling the robot to move ahead straightly when each of the minimum distance values detected by the sensors on both the left side and the right side of the robot exceeds the preset obstacle critical distance, and the minimum distance value detected by the sensors on the middle part of the robot exceeds the preset middle part distance threshold value.

Preferably, the obstacle critical distance value is greater than a nearest critical distance and is less than a farthest critical distance, the device further comprises:

a third turning unit configured for when the minimum distance value detected by the sensors on the middle part of the robot exceeds the preset middle part distance threshold value, the minimum distance value detected by the sensors on either the left side or the right side of the robot is less than the preset obstacle critical distance, and the minimum distance value detected by the sensors on the other of the left side and the right side of the robot exceeds the farthest critical distance value, turning the robot towards the other of the left side and the right side of the robot by a second angle; wherein the second angle is less than 90 degrees and is greater than 0 degree.

Preferably, the device further comprises:

a fourth turning unit configured for obtaining a previous angle value to be compensated and turning the robot according to the angle value to be compensated if the minimum distance value detected by the sensors on the middle part of the robot exceeds the preset middle part distance threshold value, and each of the minimum distance values detected by the sensors on both the left side and the right side of the robot exceeds the preset obstacle critical distance.

Preferably, each of the left side and the right side of the robot is provided with five sensors, which include two sensors arranged on a palm and an elbow respectively and three sensors arranged at outer sides of an ankle-joint, a knee-joint and a hip-joint respectively; the middle part of the robot is provided with seven sensors which include two sensors arranged on the head, three sensors arranged on the body portion and two sensors arranged on a front part of a sole and a front part of a knee respectively.

The device for automatic obstacle avoidance of the robot in the embodiment of the present invention corresponds to the methods for automatic obstacle avoidance of the robot described in the embodiments I-III, and is not repeatedly described here.

In some embodiments provided by the present invention, it should be understood that the disclosed systems, devices and methods can be realized by other ways. For example, the device embodiment described above is merely for schematic; for example, the dividing of the units is merely a division of logic function, in an actual implementation, there can be other dividing ways; for example, a plurality of units or components can be combined or integrated into another system, or some characteristics can be ignored or not executed. In another aspect, the displayed or discussed mutual coupling, direct coupling, or communication connection can be an indirect connection or a communication connection through some interfaces, devices or units, and can be in an electrically connected form, a mechanically connected form, or other forms.

The units being described as separated parts can be or not be physically separated, the components displayed as units can be or not be physical units, that is, the components can be located at one place, or be distributed onto a plurality of network elements. According to actual requirements, some or all of the units can be selected to implement the purposes of the technical solution of the present embodiment.

In addition, in each of the embodiments of the present invention, all of the functional units can be integrated into a single processing unit; each of the units can also exists physically and independently, and two or more than two of the units can also be integrated into a single unit. The aforesaid integrated units can either be realized in the form of hardware, or be realized in the form of software functional units.

If the integrated units are implemented in the form of software functional units and are sold or used as independent products, they can be stored in a computer readable storage medium. Based on this comprehension, the technical solutions of the present invention, or the part thereof that has made contribution to the prior art, or the whole or a part of the technical solutions, can be essentially embodied in the form of software products, the computer software products can be stored in a storage medium, which comprises some instructions and is configured for instructing a computer device (which can be a personal computer, a server, a network device, or the like) to perform the whole or a part of the method in each of the embodiments of the present invention. The aforesaid storage medium comprises various mediums which can store procedure codes, such as a USB flash disk, a movable hard disk, a ROM (Read-Only Memory), A RAM (Random Access Memory), a magnetic disk, a disk, or the like.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A method for automatic obstacle avoidance of a robot, comprising:
obtaining distance values between the robot and an obstacle detected by a plurality of sensors arranged on a left side, a middle part and a right side of the robot respectively; the left side of the robot comprises sensors arranged on a left hand and a left foot of the robot respectively, the right side of the robot comprises sensors arranged on a right hand and a right foot of the robot respectively, and the middle part of the robot comprises sensors arranged on a head and a body portion of the robot respectively;
when a minimum distance value detected by the sensors on the middle part of the robot is less than a preset middle part distance threshold value, if a minimum distance value detected by the sensors on either the left side or the right side exceeds a preset obstacle critical distance, turning the robot by 90 degrees towards the side where the minimum distance value detected by the sensors exceeds the preset obstacle critical distance, and recording a first turning angle;
when the minimum distance value detected by the sensors on the middle part of the robot exceeds the preset middle part distance threshold value, if only the minimum distance value detected by the sensors on the left side exceeds the preset obstacle critical distance, turning the robot towards the left side by a first angle value; if only the minimum distance value detected by the sensors on the right side exceeds the obstacle critical distance, turning the robot by the first angle value and recording a second turning angle; wherein the first angle value is less than 90 degrees and is greater than 0 degree.

2. The method according to claim 1, further comprising:
when each of the minimum distance values detected by the sensors on both the left side and the right side of the robot is less than the preset obstacle critical distance, turning the robot by 180 degrees;
when each of the minimum distance values detected by the sensors on both the left side and the right side of the robot exceeds the preset obstacle critical distance, and the minimum distance value detected by the sensors on the middle part of the robot exceeds the preset middle part distance threshold value, controlling the robot to move ahead straightly.

3. The method according to claim 1, wherein the obstacle critical distance value is greater than a nearest critical distance represented as DRN and is less than a farthest critical distance represented as DRF, and the method further comprises:
when the minimum distance value detected by the sensors on the middle part of the robot exceeds the preset middle part distance threshold value, the minimum distance value detected by the sensors on either the left side or the right side of the robot is less than the preset obstacle critical distance, and the minimum distance value detected by the sensors on the other of the left side and the right side of the robot exceeds the farthest critical distance value, turning the robot towards the other of the left side and the right side of the robot by a second angle; wherein the second angle is less than 90 degrees and is greater than 0 degree.

4. The method according to claim 1, further comprising:
if the minimum distance value detected by the sensors on the middle part of the robot exceeds the preset middle part distance threshold value, and each of the minimum distance values detected by the sensors on both the left side and the right side of the robot exceeds the preset obstacle critical distance, obtaining a previous angle value to be compensated, and turning the robot according to the angle value to be compensated.

5. The method according to claim 1, wherein, each of the left side and the right side of the robot is provided with five sensors, which include two sensors arranged on a palm and an elbow respectively and three sensors arranged at outer sides of an ankle-joint, a knee-joint and a hip-joint respectively; the middle part of the robot is provided with seven sensors, which include two sensors arranged on the head, three sensors arranged on the body portion and two sensors arranged on a front part of a sole and a front part of a knee respectively.

6. A device for automatic obstacle avoidance of a robot, comprising:
a distance value obtaining unit configured for obtaining distance values between the robot and an obstacle detected by a plurality of sensors on a left side, a middle part and a right side of the robot respectively; the left side of the robot comprises sensors arranged on a left hand and a left foot of the robot respectively, the right side of the robot comprises sensors arranged on a right hand and a right foot of the robot respectively, and the middle part of the robot comprises sensors arranged on a head and a body portion of the robot respectively;
a first turning unit configured for when a minimum distance value detected by the sensors on the middle part of the robot is less than a preset middle part distance threshold value, if a minimum distance value detected by the sensors on either the left side or the right side exceeds a preset obstacle critical distance, turning the robot by 90 degrees towards the side where the minimum distance value detected by the sensors exceeds the preset obstacle critical distance, and recording a first turning angle;
a second turning unit configured for when the minimum distance value detected by the sensors on the middle part of the robot exceeds the preset middle part distance threshold value, turning the robot towards the left side by a first angle value if only the minimum distance value detected by the sensors on the left side exceeds the preset obstacle critical distance, turning the robot by the first angle value if only the minimum distance value detected by the sensors on the right side exceeds the obstacle critical distance, and recording a second turning angle; wherein the first angle value is less than 90 degrees and is greater than 0 degree.

7. The device according to claim 6, further comprising:
a rotary unit configured for turning the robot by 180 degrees when each of the minimum distance values detected by the sensors on both the left side and the right side of the robot exceeds the preset obstacle critical distance; and
a straightly moving unit configured for controlling the robot to move ahead straightly when each of the minimum distance values detected by the sensors on both the left side and the right side of the robot exceeds the preset obstacle critical distance, and the minimum distance value detected by the sensors on the middle part of the robot exceeds the preset middle part distance threshold value.

8. The method according to claim 6, wherein the obstacle critical distance value is greater than a nearest critical distance represented as DRN and is less than a farthest critical distance represented as DRF, and the device further comprises:
a third turning unit configured for when the minimum distance value detected by the sensors on the middle part of the robot exceeds the preset middle part distance threshold value, the minimum distance value detected by the sensors on either the left side or the right side of the robot is less than the preset obstacle critical distance, and the minimum distance value detected by the sensors on the other of the left side and the right side of the robot exceeds the farthest critical distance value, turning the robot towards the other of the left side and the right side of the robot by a second angle; wherein the second angle is less than 90 degrees and is greater than 0 degree.

9. The device according to claim 6, further comprising:
a fourth turning unit configured for obtaining a previous angle value to be compensated and turning the robot according to the angle value to be compensated if the minimum distance value detected by the sensors on the middle part of the robot exceeds the preset middle part distance threshold value, and each of the minimum distance values detected by the sensors on both the left side and the right side of the robot exceeds the preset obstacle critical distance.

10. The device according to claim 6, wherein, each of the left side and the right side of the robot is provided with five sensors, which include two sensors arranged on a palm and an elbow respectively and three sensors arranged at outer sides of an ankle-joint, a knee-joint and a hip-joint respectively; the middle part of the robot is provided with seven sensors, which include two sensors arranged on the head, three sensors arranged on the body portion and two sensors arranged on a front part of a sole and a front part of a knee respectively.
